(19) United States
(12) Patent Application Publication
(10) Pub. No.: US 2025/0199111 A1
(43) Pub. Date: Jun. 19, 2025

(54) DEVICE AND METHOD FOR JOINT COMMUNICATIONS AND SENSING SYSTEMS

(71) Applicant: HUAWEI TECHNOLOGIES CO., LTD., Shenzhen (CN)

(72) Inventors: Yun Yaw Chu, Boulogne Billancourt (FR); Nassar Ksairi, Boulogne Billancourt (FR)

(73) Assignee: HUAWEI TECHNOLOGIES CO., LTD., Shenzhen (CN)

(21) Appl. No.: 19/064,406

(22) Filed: Feb. 26, 2025

Related U.S. Application Data
(63) Continuation of application No. PCT/EP2022/073845, filed on Aug. 26, 2022.

(51) Int. Cl. G01S 7/00; G01S 13/931

(52) U.S. Cl. CPC G01S 7/006; G01S 13/931

(57) ABSTRACT

The present disclosure relates to devices and methods for a system configured for joint communications and radar. The system comprises a first terminal that is capable of radar and communications and a second terminal that is capable of only communications. A network device is disclosed to provide a list to the first terminal. The list comprises pilot signal information assigned to the first terminal and the second terminal. Each pilot signal information assigned to a respective terminal comprises a pilot sequence ID, terminal ID, and timing synchronization information. The first terminal receiving the list is configured to perform radar sensing based on the list. For example, the first terminal is capable of detecting the pilot signal emitted from the second terminal and reflections thereof. Then, radar sensing (e.g., object detection) can be performed based thereon. In this way, multi-node radar sensing is achieved.

### CROSS-REFERENCE TO RELATED APPLICATIONS

This application is a continuation of International Application No. PCT/EP2022/073845, filed on Aug. 26, 2022, the disclosure of which is hereby incorporated by reference in its entirety.

### TECHNICAL FIELD

The present disclosure relates to devices and methods in the fields of radars and wireless communications. In particular, the disclosure relates to devices and methods for mitigating interference between radar and communications.

### BACKGROUND

Radar systems are commonly used for detecting objects (sensing). For instance, autonomous vehicles may be equipped with radar for various purposes, such as self-driving, parking assistance, and collision prevention. To limit the adverse effects of mutual vehicular radar interference, typical radar designs employ various ranges of frequencies, modulation schemes, emission powers, and/or radiation patterns in order to minimize radio interference occurrences as much as possible. In addition, various signal processing algorithms are required to be implemented in order to improve the resiliency of detection algorithms when interferences originated by other radar emitters cannot be sufficiently suppressed from the incoming radio signal. In this disclosure, the radar system can also be referred to as a sensing system.

Although being relatively efficient in common situations, these techniques involve greater design complexity and thereby increasing the production and maintenance costs. Moreover, these techniques do not aim to address the root cause of interferences, but are in fact counter-measures techniques operating in a best effort basis when the radar system is in presence of unknown interference sources. Thereby, the necessity of implementing multiple methods for interference mitigation on vehicular applications stems mostly from the lack of a global consensus across radar providers.

Recently, the concept of sensing integrated with communications has drawn significant attention. For instance, the autonomous vehicles may be capable of radar and communications. For example, the communications may be vehicle-to-everything (V2X) communications. This suggests that communicating devices may also incorporate sensing features, such as radar functionality, with both functionalities either co-existing or symbiotically benefitting each other. For instance, technologies of joint communications and radar (JCR), joint radar and communications (JRC), joint communications and radar sensing (JCRS), joint communications and sensing (JCAS or JCS), or dual-function radar-communications (DFRC) have been proposed.

On one hand, communications signals can be used for sensing purposes and can help to achieve high accuracy localization, activity sensing, or environment scouting. On the other hand, sensing features can be used in order to increase the quality of service and the performance of communications with better interference mitigation, channel prediction, or beam steering/focusing/alignment. Another motivation is that communications and sensing signal processing may share common resources. In radar, predetermined waveform signals are employed for sensing. In communications, transceivers utilize predetermined pilot signals (also known as pilot sequences or pilots) for estimating a time-varying channel.

A pilot signal is a signal known to its intended receivers and occupying a known subset of the radio resources of the wireless system, e.g., the time-frequency-code-space resources. Space resources are on space domains. The space domain may be referred to as a beam or antenna domain. Different pilot signals are made to occupy different resource subsets. For example, pilots intended for estimation of multiple-antenna channels in current cellular standards are beamformed signals, each with a different beamforming pointing in a different angle-of-departure direction, and each occupying a different set of orthogonal frequency-division multiplexing (OFDM) subcarriers. In a communications system, the allocation of different pilots to different emitters in a cell area is typically decided by a base station (BS) serving that area.

### SUMMARY

In a joint radar and communications system, radar and communications may share overlapping operating frequencies, e.g., beyond 6 GHz or 10 GHz. For example, automotive radar operation frequencies may be in a range of 24 GHz to 79 GHz. Some communications systems may operate at millimeter wave (mmWave) frequency. With data transmission of the communications and radar sensing coexisting, interference can reduce the transmission reliability of the data communication. The accuracy of the radar sensing can also be negatively impacted.

Moreover, the absence of consensus between radar designs implies that radar design needs to take into consideration multiple techniques to mitigate radar interferences without a guarantee to successfully detect an obstacle in all situations.

In view of the above-mentioned problems and disadvantages, this disclosure aims to address interference mitigation in joint communications and sensing systems in a coordinated manner.

These and other objectives are achieved by the subject matter of the independent claims. Further implementation forms are apparent from the dependent claims, the description and the drawings.

An idea described in the present disclosure is to provide a mechanism to provide information of pilot signals of other terminal(s) to terminal(s) with radar and communications capabilities so that the terminal(s) with radar and communications capabilities may detect these pilot signals for radar sensing and filter interference signals.

A first aspect of the present disclosure provides a network device for a system configured for joint communications and radar. The system comprises one or more first terminals that are capable of radar and communications, and one or more second terminals that are capable of communications only (i.e., not capable of radar). The one or more first terminals and the one or more second terminals are connectable to the network device. The network device is configured to obtain a list comprising pilot signal information assigned to the one or more first terminals and the one or more second terminals, and provide the list to at least one of the one or more first terminals.

Each pilot signal information assigned to a respective terminal comprises the following information:
an identification (ID) of a pilot sequence allocated to the respective terminal;
timing synchronization information between the respective terminal and the network device; and
an ID of the respective terminal.

Optionally, pilot signal information assigned to a respective first terminal may relate to a pilot signal that can be used for communications and/or radar. That is, the pilot signal of the respective first terminal may be a communications pilot and/or radar pilot.

Optionally, the ID of the pilot sequence (or simply referred to as a “pilot ID”) may be a pilot key code. The pilot key code may be indexed to a unique signal sequence from a codebook set. The codebook set (or simply codebook) may be a pre-determined or pre-loaded codebook across the system. For instance, the codebook may be pre-defined by a standard, which is followed by the network device and each terminal (including each first and second terminal).

Optionally, the network device may be further configured to determine pilot signals for the terminals (including the one or more first terminals and the one or more second terminals) so as to minimize interferences between the terminals. The pilot sequences between mutual terminals are orthogonal.

Optionally, the timing synchronization information may comprise a timing advance value associated with each pilot ID. The timing advance value may be used used for frame transmission synchronization between the network device and the respective terminal.

Optionally, the ID of the respective terminal (or simply referred to as a “terminal ID”) may be any identification code that can uniquely identify the respective terminal in the system. For instance, the ID may be an IP address, medium access control (MAC) address, international mobile subscriber identity (IMSI), or international mobile equipment identity (IMEI). It is noted that the terminal ID is not limited to these examples. Other suitable values may be used as the terminal ID.

In this way, the interferences during radar sensing can be mitigated thanks to the network device providing the list to the at least one of the one or more first terminals. In a mono-static radar scheme, radar pilots and/or communications pilots emitted from other terminals and echoes associated therewith are considered to be interferences. Thanks to the network device providing the list, the at least one first terminal receiving the list can easily distinguish (or identify, detect) radio illuminations emitted from other terminals in proximity. These radio illuminations may be pilot signals and/or reflections of the pilot signals, in which the pilot signals are coordinated by the network device for the communications and/or radar. These pilot signals may be selected from a set of predefined orthogonal pilot signals (e.g., from a pre-defined codebook), which are designed to minimize mutual interference in the communications links.

Moreover, no hardware modification is needed to mitigate radar interference. Therefore, the design complexity and the production cost of the at least one first terminal can be kept relatively low, compared to other hardware solutions to mitigate radar interference.

In an implementation form of the first aspect, the pilot signal information may further comprise position information of the respective terminal.

In this way, the at least one first terminal receiving the list may perform radar sensing based on pilot signals and/or reflections of the pilot signals (also referred to as radio illuminations) from other terminals and the position of other terminals. Thus, a multi-static radar scheme can be realized. In the multi-static radar scheme, the at least one first terminal receiving the list may take advantage of the radio illuminations emitted from other terminals in proximity. The multi-static radar scheme can offer superior sensing performance than a mono-static radar scheme, thanks to the increased spatial diversity and increased maximum range of radar. The radio illuminations may comprise signals directly emitted from other terminals and reflections (or echoes) of the signals directly emitted from other terminals.

In an implementation form of the first aspect, the pilot signal information may further comprise an expiration time of the pilot signal information.

This may introduce flexibility for sensing. For instance, a part or all of the terminals may be moving. Depending on the moving speed of the respective terminal, the network device may be configured to determine a respective expiration time.

In an implementation form of the first aspect, the ID of the respective terminal may comprise a temporary and/or anonymized ID code.

This may introduce privacy. Instead of using a real ID to identify a respective terminal, using the temporary and/or anonymized ID code can protect privacy.

Optionally, the network device may be configured to store a record indicating a relationship between the temporary (and/or anonymized) ID code and a real terminal ID of the respective terminal. The real terminal ID may be any one of an IP address, medium access control (MAC) address, international mobile subscriber identity (IMSI), international mobile equipment identity (IMEI), and the like.

In an implementation form of the first aspect, the network device may be further configured to determine one or more clusters based on beam orientation of the pilots and/or location information of the one or more first terminals and the one or more second terminals.

That is, the network device may be further configured to group the terminals into clusters (or simply referred to as “clustering”). The clustering may be based on, but not limited to, the proximity of the connected terminals, parameterizable distance criteria, and/or the terminals within a respective beam orientation (e.g. beam main lobe direction) of the network device.

The list may comprise pilot signal information associated with terminals in a respective cluster. That is, the network device may be configured to deliver pilot signal information only relative to terminals within the same cluster.

In this way, the number of entries in the list may be shortened. This may reduce the search space for determining a corresponding (matched) pilot signal on the at least one first terminal receiving the list.

In an implementation form of the first aspect, the pilot signal information may further comprise a cluster ID of the respective terminal.

In this way, the at least one first terminal receiving the list may be configured to determine, based on the cluster ID, which terminals are in the same cluster, and then perform radar sensing based on pilot signals from the terminals that are in the same cluster.

In an implementation form of the first aspect, the pilot signal information may further comprise a network device ID.

In this way, collaboration across network devices is facilitated. For instance, the network device may be further configured to provide the list to a further first terminal that is in a neighbouring cell (e.g. in an overlapping region), or that is currently attached to a neighbouring network device. The further first terminal can also perform radar sensing exploiting the pilot signal information comprised in the list.

In an implementation form of the first aspect, the network device may be further configured to transmit one or more pilot signals, and the list further comprises pilot signal information transmitted by the network device.

Since the network device usually has a wider signal overage than any terminal, this may increase the radar sensing coverage area of the at least one first terminal receiving the list.

In an implementation form of the first aspect, before providing the list to the at least one of the one or more first terminals, the network device may be further configured to receive, from the at least one of the one or more first terminals, a request for requesting the list.

Optionally, the request may be a radar sensing cooperation (or enhancement) request, which may be used to indicate that the at least one terminal requests cooperation from the network device in the radar sensing that the at least one terminal is going to perform. To cooperate the radar sensing, the network device is configured to provide the list in response to the request.

In this way, the network device can be aware of when to provide the list to the at least first terminal and can timely provide an up-to-date list to the at least one first terminal requesting the list.

In an implementation form of the first aspect, the network device may be further configured to send a request to each of the one or more first terminals for updating and/or removing a part or all of the pilot signal information comprised in the list.

It is noted that the each of the one or more first terminals herein may refers to any first terminal that has received a list from the network device.

In this way, the pilot signal information comprised in the list may be timely updated or erased when no longer necessary.

In an implementation form of the first aspect, the network device may be further configured to:
provide the list to a further network device; and/or
receive a further list from the further network device.

Optionally, the further list may comprise one or more entries carrying pilot signal information that are coordinated by the further network device to terminals associated therewith.

Optionally, the network device and the further network device may be communicable via a dedicated interface, e.g., an X2 interface.

In this way, cooperation between network devices is facilitated and radar range may be extended, e.g., to a neighbouring cell area managed by the further network device.

A second aspect of the present disclosure provides a first terminal for a system configured for joint communications and radar. The system comprises a network device and one or more second terminals that are capable of communications only. The first terminal and the one or more second terminals are connectable to the network device. The first terminal is capable of radar and communications and is configured to receive, from the network device, a list comprising pilot signal information assigned to the first terminal and at least one of the one or more second terminals. The first terminal is further configured to perform radar sensing taking account of the pilot signal information comprised in the list.

Each pilot signal information assigned to a respective terminal comprises the following information:
an ID of a pilot sequence allocated to the respective terminal;
timing synchronization information between the respective terminal and the network device; and
an ID of the respective terminal.

Optionally, the pilot signal allocated to the first terminal may be a communications pilot and/or a radar pilot. That is, the first terminal may be further configured to transmit one or more pilot signals based on the assigned pilot signal information in the list. Alternatively or additionally, the first terminal may be configured to transmit one or more radar signals based on the assigned pilot signal information. In another word, the first terminal may be configured to transmit a pilot signal based on the assigned pilot signal information in the list, in which the pilot signal can be used for channel estimation purposes and/or for radar sensing purposes.

Optionally, the ID of the pilot sequence (or pilot ID) may be a pilot key code. The pilot key code may be directly indexed to a unique signal sequence of a codebook set. The codebook may be a pre-determined or pre-loaded codebook across the system. For instance, the codebook may be pre-defined by a standard, which is followed by the network device and each terminal (including the first and second terminal).

Optionally, the timing synchronization information may comprise a timing advance value associated with each pilot ID. The timing advance value may be used used for frame transmission synchronization.

Optionally, the ID of the respective terminal (or terminal ID) may be any identification code that can uniquely identify the respective terminal in the system. For instance, the ID may be an IP address, MAC address, IMSI, or IMEI. It is noted that the terminal ID is not limited to these examples. Other suitable values may also be used.

In this way, the interferences during radar sensing can be mitigated thanks to the network device providing the list to the at least one of the one or more first terminals. In a mono-static radar scheme, radar pilots and/or communications pilots emitted from other terminals and echoes associated therewith are considered as interferences. Thanks to the network device providing the list, the at least one first terminal with radar capabilities can easily distinguish radar illuminations emitted from other terminals in proximity. These radar illuminations may be pilot signals coordinated by the network device for the communications and/or radar. These pilot signals may be selected from a set of predefined orthogonal pilot signals, which are designed to minimize mutual UE interference in the communications links.

Moreover, no hardware modification is needed to mitigate radar interference. Therefore, the design complexity and the production cost of the at least one first terminal can be kept relatively low, compared to other hardware solutions to mitigate interference during radar sensing.

In an implementation form of the second aspect, for performing the radar sensing, the first terminal may be configured to:
receive one or more echo signals over radar; and
determine whether the one or more echo signals match one or more pilot signals defined in the list.

It is noted that the one or more echo signals received over radar may be understood as radio illuminations received over radar. The radio illuminations may comprise signals directly emitted from other terminals (other than the first terminal receiving the list) and reflections of the signals directly emitted from other terminals

In an implementation form of the second aspect, for performing the radar sensing, the first terminal may be further configured to send a pilot signal over radar based on pilot signal information that is comprised in the list and is assigned to the first terminal.

Optionally, the pilot signal sent over radar is for radar sensing. In this way, the interference caused by radar signal emitted from the first terminal to other terminals, thanks to the orthogonality between pilot signals.

In an implementation form of the second aspect, after determining that there is one or more of the one or more echo signals matching the one or more pilot signals defined in the list (simply referred to “one or more matched echo signals”), the first terminal may be configured to perform radar sensing based on the matched one or more echo signals.

Optionally, after determining that there is one or more unmatched echo signals that do no match any pilot signal defined in the list, the first terminal may be configured to discard the one or more unmatched echo signals received over radar. That is, the one or more unmatched echo signals can be filtered out, and are not considered for radar sensing.

In this way, the first terminal may selectively filter interference signals from all the echo signals received over the radar. Thus, the radar sensing performance can be enhanced, and the precision of the radar sensing can be increased.

In an implementation form of the second aspect, the first terminal may be further configured to provide location information to the network device.

Optionally, the location information of the first terminal may be used as a reference point for radar sensing by other terminals. In this way, the radar sensing can be performed in a coordinated manner and multi-static radar sensing can be realized in the system.

In an implementation form of the second aspect, the first terminal may be further configured to:
receive a request from the network device for updating and/or deleting a part or all of the pilot signal information comprised in the list; and
update and/or delete a part or all of the pilot signal information comprised in the list according to the request.

In this way, the list may be flexibly maintained.

A third aspect of the present disclosure provides a system comprising one or more network devices of the first aspect or any implementation form thereof, one or more first terminals of the second aspect or any implementation form thereof, and one or more second terminals that are capable of communications only.

A fourth aspect of the present disclosure provides a method for a system configured for joint communications and radar. The system comprises one or more first terminals that are capable of radar and communications, and one or more second terminals that are capable of communications only. The one or more first terminals and the one or more second terminals are connectable to a network device. The method comprises the following steps:
obtaining, by a network device, a list comprising pilot signal information assigned to the one or more first terminals and the one or more second terminals; and
providing, by the network device, the list to at least one of the one or more first terminals.

Each pilot signal information assigned to a respective terminal comprises the following information:
an ID of a pilot sequence allocated to the respective terminal;
timing synchronization information between the respective terminal and the network device; and
an ID of the respective terminal.

In an implementation form of the fourth aspect, the pilot signal information may further comprise position information of the respective terminal.

In an implementation form of the fourth aspect, the pilot signal information may further comprise an expiration time of the pilot signal information.

In an implementation form of the fourth aspect, the ID of the respective terminal may comprise a temporary and/or anonymized ID code.

In an implementation form of the fourth aspect, the method may further comprise determining, by the network device, one or more clusters based on beam orientation of the pilots and/or location information of the one or more first terminals and the one or more second terminals.

In an implementation form of the fourth aspect, the pilot signal information may further comprise a cluster ID of the respective terminal.

In an implementation form of the third aspect, the pilot signal information may further comprise a network device ID.

In an implementation form of the fourth aspect, the method may further comprise transmitting, by the network device, one or more pilot signals, and the list further comprises pilot signal information transmitted by the network device.

In an implementation form of the fourth aspect, before providing the list to the at least one of the one or more first terminals, the method may further comprise receiving, by the network device from the at least one of the one or more first terminals, a request for requesting the list.

In an implementation form of the fourth aspect, the method may further comprise sending, by the network device, a request to each of the one or more first terminals for updating and/or removing a part or all of the pilot signal information comprised in the list.

In an implementation form of the fourth aspect, the method may further comprise the following steps:
providing, by the network device, the list to a further network device; and/or
receiving, by the network device, a further list from the further network device.

The method of the fourth aspect and its implementation forms may share the same optional features and achieve the same advantages and effects as described above for the network device of the first aspect and its implementation forms.

A fifth aspect of the present disclosure provides a method for a system configured for joint communications and radar. The method is performed by a first terminal that is capable of radar and communications. The system comprises a network device and one or more second terminals that are capable of communications only. The first terminal and the one or more second terminals are connectable to the network device. The method comprises the following steps:
receiving, by the first terminal from the network device, a list comprising pilot signal information assigned to the first terminal and each of the one or more second terminals; and
performing, by the first terminal, radar sensing taking account of the pilot signal information comprised in the list,

Each pilot signal information assigned to a respective terminal comprises:
an identification, ID, of a pilot sequence allocated to the respective terminal;
timing synchronization information between the respective terminal and the network device; and
an ID of the respective terminal.

In an implementation form of the fifth aspect, the step of performing the radar sensing may comprise the following steps:
receiving, by the first terminal, one or more echo signals over radar; and
determining, by the first terminal, whether the one or more echo signals match one or more pilot signals defined in the list.

In an implementation form of the fifth aspect, the step of performing the radar sensing may further comprise sending, by the first terminal, a pilot signal over radar based on pilot signal information that is comprised in the list and is assigned to the first terminal.

In an implementation form of the fifth aspect, after determining that there is one or more of the one or more echo signals matching the one or more pilot signals defined in the list, the method may comprise performing, by the first terminal, radar sensing based on the matched one or more echo signals received over radar.

In an implementation form of the fifth aspect, the method may further comprise providing, by the first terminal, location information to the network device.

In an implementation form of the fifth aspect, the method may further comprise the following steps:
receiving, by the first terminal, a request from the network device for updating and/or deleting a part or all of the pilot signal information comprised in the list; and
updating and/or deleting, by the first terminal, a part or all of the pilot signal information comprised in the list according to the request.

The method of the fifth aspect and its implementation forms may share the same optional features and achieve the same advantages and effects as described above for the first terminal of the second aspect and its implementation forms.

A sixth aspect of the present disclosure provides a computer program product comprising a program code for performing the method according to the fourth aspect or any implementation form thereof, when executed on a computer.

A seventh aspect of the present disclosure provides a computer program product comprising a program code for performing the method according to the fifth aspect or any implementation form thereof, when executed on a computer.

An eighth aspect of the present disclosure provides a computer-readable medium comprising instructions which, when executed by a computer, cause the computer to carry out the method according to any one of the fourth aspect or any implementation form thereof.

A ninth aspect of the present disclosure provides a computer-readable medium comprising instructions which, when executed by a computer, cause the computer to carry out the method according to any one of the fifth aspect or any implementation form thereof.

A tenth aspect of the present disclosure provides a chipset comprising instructions which, when executed by the chipset, cause the chipset to carry out the method according to any one of the fourth aspect or any implementation form thereof.

An eleventh aspect of the present disclosure provides a chipset comprising instructions which, when executed by the chipset, cause the chipset to carry out the method according to any one of the fifth aspect or any implementation form thereof.

It has to be noted that all devices, terminals, elements, units, and means described in the present application could be implemented in software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description, a specific functionality or step to be performed by external entities is not reflected in the description of a specific detailed element of that entity, which performs that specific step or functionality, it should be clear for a skilled person that these methods and functionalities can be implemented in respective software or hardware elements, or any kind of combination thereof.

### BRIEF DESCRIPTION OF DRAWINGS

The above-described aspects and implementation forms will be explained in the following description in relation to the enclosed drawings, in which

FIG. 1 shows an example of a network device and a first terminal according to this disclosure;

FIG. 2 shows a further example of a network device and a first terminal according to this disclosure;

FIG. 3 shows an example of network devices exchanging pilot signal information according to this disclosure;

FIG. 4 shows an example of an application scenario according to this disclosure;

FIG. 5A shows an example of a clustering based on location information of terminals;

FIG. 5B shows an example of a clustering based on main beam lobe direction;

FIG. 6 shows a diagram of a method 600 according to this disclosure; and

FIG. 7 shows a diagram of a further method 700 according to this disclosure.

### DETAILED DESCRIPTION OF EMBODIMENTS

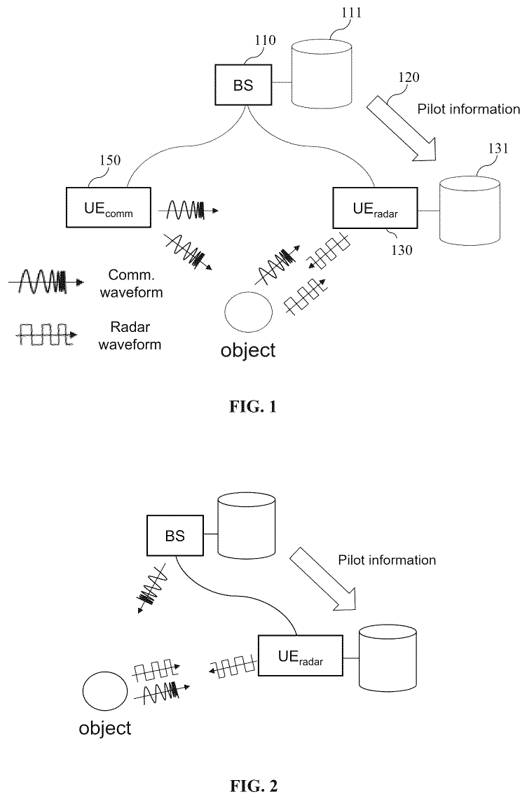

In FIGS. 1-7, corresponding elements may share the same features and may function likewise.

FIG. 1 shows an example of a network device and a first terminal according to this disclosure. The network device is exemplarily depicted in FIG. 1 as a base station (BS) 110. The first terminal is exemplarily depicted in FIG. 1 as user equipment (UE) 130 capable of radar and communications (which is labelled as UE_{radar}). FIG. 1 also shows a second terminal depicted as UE capable of only communications (which is labelled as UE_{comm}) 150. The communications capabilities in this disclosure may include but not limited to supporting the fourth generation of mobile communication (4G), 5G, 6G, V2X, Internet-of-Things (IoT) and the like. Generally speaking, the communications capabilities may refer to supporting any communication system where pilot signals are used for channel estimation.

In this disclosure, for the sake of simplicity, UE_{radar} and UE_radar may be used interchangeably; UE_{comm} and UE_comm may be used interchangeably. It is noted that though one UE_radar and one UE_comm are depicted and mentioned with respect to FIG. 1, there may be more than one UE_radar and/or more than one UE_comm. It is further noted that the network device in the present disclosure may be a BS, an E-UTRAN Node B (eNode B, or eNB), a gNB, or an access point. In the following, the term “BS” may be used to refer to a network device; the term “UE_radar” may refer to a first terminal; the term “UE_comm” may refer to a second terminal. The term “communication” is shortened to “comm” in the drawings.

As shown exemplarily in FIG. 1, the BS 110 is configured to obtain a list 120 comprising pilot signal information assigned to the UE_radar 130 and the UE_comm 150, and provide the list 120 to the UE_radar 130. Each pilot signal information assigned to a respective terminal comprises at least one ID of a pilot sequence, a respective terminal ID, and timing synchronization information.

Optionally, the ID of the pilot sequence may be a pilot identification key code, which can be directly indexed to a unique radio frequency (RF) signal sequence (or pilot sequence) from a known codebook set (or codebook). The codebook may be pre-defined, e.g., according to a standard adopted by the BS 110, UE_radar 130, and UE_comm 150. For instance, the codebook may be defined in 3rd Generation Partnership Project (3GPP) technical specifications.

Optionally, the terminal ID may be an anonymized and/or temporary emitter identification code. The terminal ID may be associated with one or more pilot identification key codes.

Optionally, the pilot signal information may further comprise an expiring time for each pilot ID.

Optionally, the timing synchronization information may comprise a corresponding timing advance value used for frame transmission synchronization between the network device and the respective terminal.

Optionally, the timing advance values for each pilot signal may be used for synchronization, e.g., among terminals as multi-static radar nodes. That is, the first terminal may determine a delay between its own signal frame timing and the signal frame timing of other terminals. With this information, the first terminal can estimate the delay between the moment any of these pilots are transmitted and the moment a pilot is received (possibly after being reflected or scattered by a target or an object to be detected) at the first terminal.

Optionally, the pilot signal information may further comprise positioning data (or location information) of the respective terminal (if such data is known and shared by the BS 110).

Optionally, the BS 110 may comprise a storage unit 111 adapted to store pilot signal information of all connected terminals, e.g., in a format of a database. The UE_radar 130 may comprise a storage unit 131 adapted to store the list 120. It is noted that the storage units 111, 131 may be an internal storage medium or external storage medium. This is not limited in this disclosure.

For the UE_radar 130, the list 130 not only comprises pilot signal information assigned to the UE_radar 130, but also comprises pilot signal information assigned to other terminal(s) (in this case, the UE_comm 150). The UE_comm 150 in this way may contribute to radar sensing performed by the UE_radar 130 as a multi-static radar node. The pilot emitted from the UE_comm 150 can be known to the UE_radar 130 based on the list. In the multi-static radar scheme, the UE_radar 130 may additionally detect radio illuminations of signals emitted from other terminal(s), e.g., the UE_comm 150 in this case. As shown in FIG. 1, the UE_radar 130 may not only receive echoes of radar signals emitted from itself, but also receive pilot signals emitted from the UE_comm 150 and echoes thereof. In this way, more information is available for radar sensing (e.g., object detection), and the accuracy of radar sensing can be improved. Moreover, the range of radar sensing may also be extended. For example, a pilot signal received by the UE_radar 130 that is directly emitted from the UE_comm 150 may be used as a reference pilot signal for radar sensing based on echoes or reflections of the same pilot signal.

Due to the orthogonality between pilot sequences, the communications waveform and the radar waveform are substantially orthogonal between each other. Therefore, interference between communications and radar sensing in the same (joint) system can be reduced. It is noted that the joint system may be (for example but not limited to) any one of a JCR, JRC, JCRS, JCAS, JCS, and DFRC system.

Optionally, the UE_radar 130 may distinguish between useful echoes and interference received during radar sensing. The useful echoes may be echoes of pilot signals emitted from other terminals that are defined in the list. The useful echoes may be used as additional inputs for detecting an object. That is, the UE_radar 130 may be further configured to determine whether one or more signals received over radar match any pilot signal defined in the list. If a received signal matches a pilot signal defined in the list, then the UE_radar 130 may perform radar sensing taking account of the received signal. If a received signal does not match any pilot signal defined in the list, then the UE_radar 130 may be configured to discard the received signal and does not take account of the received signal for radar sensing. In this way, interference may be efficiently filtered out during radar sensing and the performance of radar sensing can be increased.

Optionally, before providing the list by the BS 110 to the UE_radar 130, the UE radar 130 may be configured to send a request message to the BS 110. The request message may be used to request assistance (or cooperation) from the BS 100 in order to enhance the radar sensing that the UE_radar 130 is going to perform. Thus, the request message may be referred to as a radar sensing cooperation request or a radar sensing enhancement request. In response to the request message, the BS 100 may be configured to provide the list to the BS_radar 130. Optionally, each radar sensing may be performed as a session, and for each session, the UE_radar 130 may be configured to send a corresponding request to the BS 110 and receive a corresponding list from the BS 110.

An example of the list provided by the BS 110 can be as follows in Table 1.

TABLE 1
An example of a list comprising pilot signal information

| | Msg. time | | | | | | Emitter |
|---|---|---|---|---|---|---|---|
| Sender ID | stamp | Assigned | Timing | | Expiration | Cluster ID | positioning |
| (Optional) | (Opt.) | Pilot ID | advance | Emitter ID | (Opt.) | (Opt.) | data (Opt.) |
| BS A | t1 | Pilot ID 1 | taus 1 | ID 1 | T1 | Cluster 1 | Absolute or |
| | | | | | | | relative |
| | | | | | | | coordinates |
| | | Pilot ID 2 | taus2 | ID 2 | T2 | Cluster 1 | Abs. or rel. |
| | | | | | | | coordinates |
| | | Pilot ID 3 | taus3 | ID 3 | T3 | Cluster 2 | Abs. or rel. |
| | | | | | | | coordinates |
| | | Pilot ID 4 | taus4 | ID 4 | T4 | Cluster 2 | Abs. or rel. |
| | | | | | | | coordinates |
| | | . . . | . . . | . . . | . . . | . . . | . . . |

It is noted that emitter ID 1 in Table 1 may correspond to UE_radar 130, and emitter ID 2 in Table 1 may correspond to UE_comm 150. Other optional emitters are not shown in FIG. 1 for the sake of simplicity.

When clustering is performed by the BS 110, a cluster ID may be comprised in the list. For example, the emitter ID 1 (UE_radar 130) and emitter ID 2 (UE_comm 150) are in the same cluster. In this case, the BS 110 may only provide these two entries as a further list to the emitter ID 1. If positioning data is known to the BS 110, the list may optionally comprise the positioning data.

It is noted that Table 1 merely gives a possible example of the list that could be provided by the BS 100 to the UE_radar. The list may be built based on different combinations of entries in Table 1. The fields in the list can also be flexibly arranged.

FIG. 2 shows a further example of a network device (BS) and a first terminal (UE_radar) according to this disclosure. The BS and UE_radar in FIG. 2 may be built based on the BS 110 and the UE_radar 130 in FIG. 1 and therefore, shall share the same features and function likewise.

In FIG. 2, the BS may be configured to transmit a pilot signal. The pilot signal reflected (or scattered) by an object (e.g., echoes) can be detected by the UE_radar.

In this case, the list provided by the BS to the UE may further comprise pilot signal information associated with the BS. Then, the ID of the BS is used in place of the terminal ID. Thus, the terminal ID comprised in the list may alternatively be referred to as an “emitter ID” used to indicate an emitter emitting the pilot signal.

Since the BS usually has a larger coverage area than any terminal, the range of radar sensing in this way can be extended.

It is noted that features disclosed in FIG. 2 may be used as additional features that are combinable with the features disclosed in FIG. 1. Alternatively, the features disclosed in FIG. 2 may be implemented in a standalone manner, e.g., as an alternative to the features disclosed in FIG. 1.

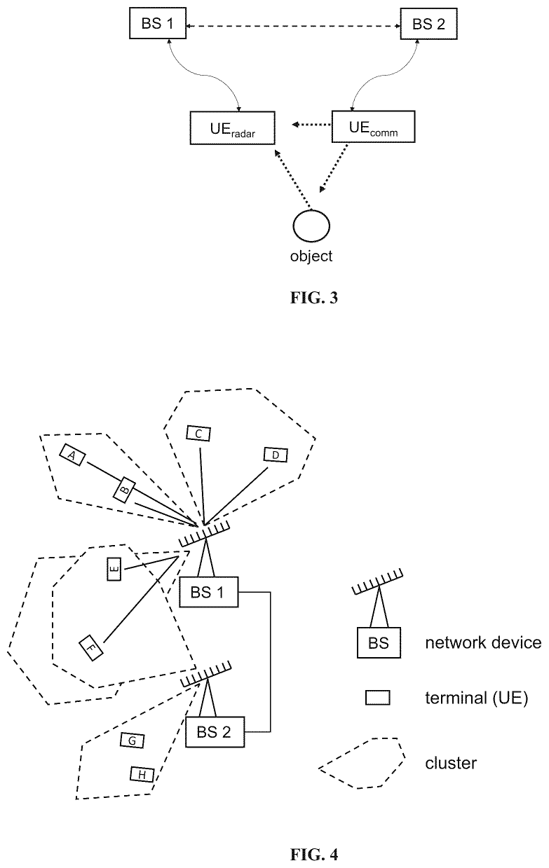

FIG. 3 shows an example of network devices exchanging pilot signal information according to this disclosure.

In FIG. 3, UE_comm is connectable to BS 2 (or is in the coverage area of BS 2), and UE_radar is connectable to BS 1. BS 1 and BS 2 may be network devices that cover neighbouring areas. The neighbouring areas may share overlapping areas. BS 2 in this case may share a list comprising pilot signal information assigned to UE_comm with BS 1. In alternative to sharing the list, the pilot signal information assigned to UE_comm can be shared with BS 1 alone. BS 1 may include the pilot signal information assigned to UE_common into a list. The list may further comprise pilot signal information assigned by BS 1 to UE_radar. BS 1 may be configured to provide the list to the UE_radar. The UE_radar therefore may perform radar sensing to detect an object that is in a signal coverage area of the UE_comm. Thus, the coverage area of radar sensing can be extended.

Similarly, when there are other UE_radar(s) in the coverage area of BS 2, BS 1 may be configured to provide the list comprising pilot signal information to BS 2.

This may be particularly useful, when UE_radar is in an overlapping area of two base stations.

FIG. 4 shows an example of an application scenario according to this disclosure.

In FIG. 4, terminals A-F are connectable to BS 1 (or are in the coverage area of BS 1), while terminals G and H are connectable to BS 2. Moreover, Terminals E and F are in an overlapping coverage area of BS 1 and BS 2. Terminal A-F comprises at least one first terminal (UE_radar) and at least one second terminal (UE_comm) of this disclosure. In this example, it is assumed that terminal E is a first terminal with radar and communications capabilities. In this case, terminal E obtains a list comprising pilot signal information from BS 1. Similarly, for BS 2, it is assumed that terminal G is a terminal first terminal with radar and communications capabilities and receives a list comprising pilot signal information from BS 2.

BS 1, as a network device according to this disclosure, may be optionally configured to determine one or more clusters based on beam orientation of the pilots and/or location information of the one or more first terminals and the one or more second terminals. As exemplarily depicted in FIG. 4, three clusters are determined by BS 1. The terminals may be clustered based on a proximity criterion, which can be a maximal distance between terminals, or a same main beam lobe direction from the network device perspective. Each cluster may be assigned with a cluster ID. The cluster ID may be comprised in the list associated with a respective terminal.

For instance, in the list, terminals C and D may be associated with cluster ID 1; terminals A and B may be associated with cluster 2; terminals E and F may be associated with cluster 3.

A terminal receiving the list may be configured to limit a search space to a same cluster. For instance, terminal E may limit a search space to a cluster with cluster ID 3 in order to reduce the search space and increase radar sensing speed. Alternatively or additionally, when terminal E needs to extend the range of radar sensing, terminal E may be configured to extend the search space to other clusters.

Optionally, similar to the case in FIG. 3, BS 1 and BS 2 may exchange pilot signal information and/or a list comprising pilot signal information of respective terminals.

For example, BS 1 may be configured to share the list with BS 2. Alternatively, BS 1 may share pilot signal information of terminals that are in the overlapping area with BS 2. That is, BS 1 may alternatively share pilot signal information assigned to terminals E and F to BS 2.

BS 2 may merge the shared pilot signal information (or the share list) and provide a list comprising pilot signal information of terminals E, F, G, and H to terminal G. In this case, terminal G may detect echoes emitted from E and F, which are located in the overlapping area.

An example of lists provided by the BS 1 and/or by the BS 2 can be as follows in Table 2.

TABLE 2
An example of lists provided by network devices

| | Msg. time | | | | | Cluster | Emitter |
|---|---|---|---|---|---|---|---|
| Sender ID | stamp | Assigned | Timing | Emitter | Expiration | ID | positioning |
| (Optional) | (Opt.) | Pilot ID | advance | ID | (Opt.) | (Opt.) | data (Opt.) |
| BS 1 | t1 | Pilot ID 1 | taus 1 | ID A | T1 | Cluster 1 | Absolute or |
| | | | | | | | relative |
| | | | | | | | coordinates |
| | | Pilot ID 2 | taus2 | ID B | T2 | Cluster 1 | Abs. or rel. |
| | | | | | | | coordinates |
| | | Pilot ID 3 | taus3 | ID C | T3 | Cluster 2 | Abs. or rel. |
| | | | | | | | coordinates |
| | | Pilot ID 4 | taus4 | ID D | T4 | Cluster 2 | Abs. or rel. |
| | | | | | | | coordinates |
| BS 1 (or | t2 | Pilot ID 5 | taus5 | ID E | T5 | Cluster 3 | Absolute or |
| BS 2) | | | | | | | relative |
| | | | | | | | coordinates |
| | | Pilot ID 6 | taus6 | ID F | T6 | Cluster 3 | Abs. or rel. |
| | | | | | | | coordinates |
| BS 2 | t3 | Pilot ID 7 | taus7 | ID G | T7 | Cluster 4 | Absolute or |
| | | | | | | | relative |
| | | | | | | | coordinates |
| | | Pilot ID 8 | taus7 | ID H | T8 | Cluster 4 | Abs. or rel. |
| | | | | | | | coordinates |

It can be seen that in this example, BS 1 may be configured to share pilot signal information assigned to terminals E and F with BS 2. BS 2 may be configured to provide a list comprising the pilot signal information assigned to terminals E, F and G to terminal G. This allows terminal G to recognize pilots emitted from terminals E and F from nearby cells (e.g., overlapping areas between BS 1 and BS 2).

It is noted the emitter IDs A-H corresponds to terminals A-H, respectively. The BS 1 may be configured to provide a list comprising pilot information of emitter IDs A-F to terminal E. The BS 1 may be configured to share pilot information of emitter IDs E and F with the BS 2. The BS 2 may be configured to provide a list comprising pilot information of emitter IDs F-H to terminal G.

It is noted that Table 2 merely gives possible examples of the list that could be provided by BS 1 and 2. The lists may be built based on different combinations of entries in Table 2. The fields in the list can also be flexibly arranged.

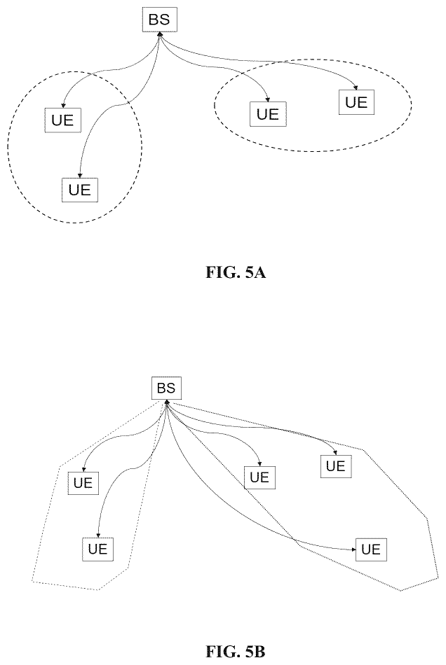

FIG. 5 shows examples of clustering performed by a network device according to this disclosure.

FIG. 5A shows an example of a clustering based on location information of terminals (UEs) The terminals herein comprise at least one first terminal and at least one second terminal. Optionally, the at least one first terminal and/or the at least one second terminal may be configured to provide location information to a network device. Correspondingly, the network device may comprise location information in a list that is provided to the at least one first terminal.

FIG. 5B shows an example of a clustering based on main beam lobe direction. UEs that are in a same main beam lobe direction with respect to a network device may be clustered. This may be particularly useful when MIMO is used for communications.

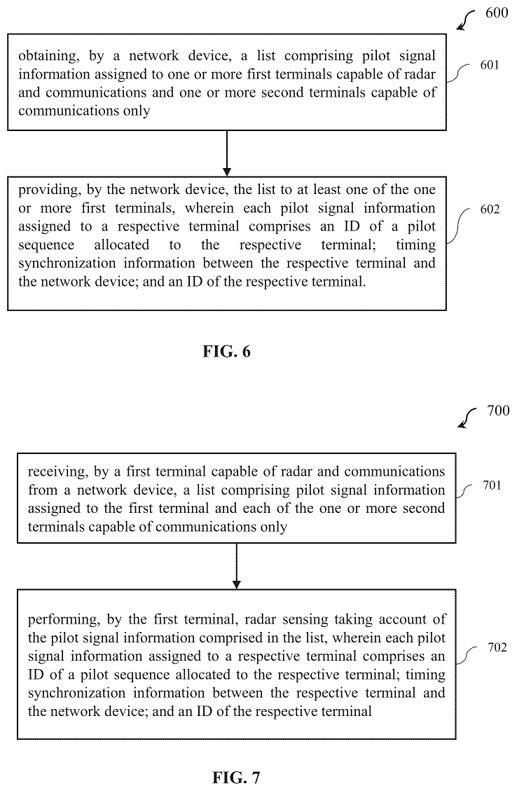

FIG. 6 shows a diagram of a method 600 according to this disclosure.

The method 600 is for a system configured for joint communications and radar and is performed by a network device. The system comprises one or more first terminals that are capable of radar and communications, and one or more second terminals that are capable of communications only. The one or more first terminals and the one or more second terminals are connectable to the network device. The method 600 comprises the following steps:
step 601: obtaining, by the network device, a list comprising pilot signal information assigned to the one or more first terminals and the one or more second terminals; and
step 602: providing, by the network device, the list to at least one of the one or more first terminals.

Each pilot signal information assigned to a respective terminal comprises:
an ID of a pilot sequence allocated to the respective terminal;
timing synchronization information between the respective terminal and the network device; and
an ID of the respective terminal.

FIG. 7 shows a diagram of a further method 700 according to this disclosure.

The method 700 is for a system configured for joint communications and radar and is performed by a first terminal that is capable of radar and communications. The system comprises a network device and one or more second terminals that are capable of communications only. The first terminal and the one or more second terminals are connectable to the network device. The method 700 comprises the following steps:
step 701: receiving, by the first terminal from the network device, a list comprising pilot signal information assigned to the first terminal and each of the one or more second terminals; and
step 702: performing, by the first terminal, radar sensing taking account of the pilot signal information comprised in the list.

Each pilot signal information assigned to a respective terminal comprises:
an ID of a pilot sequence allocated to the respective terminal;
timing synchronization information between the respective terminal and the network device; and
an ID of the respective terminal.

It is noted that the steps of methods 600 and 700 may share the same functions and details from the perspective of FIGS. 1-5 described above.

An example of a workflow according to this disclosure may be as follows.

Step 1: Multiple UEs establish communication links with a BS, some of the UEs have radar and communications capabilities (e.g., DFRC UEs), some of the UEs have only communications capabilities. The BS has assigned to each UE, one or more orthogonal communication pilot signals (e.g., pilot preambles) to be emitted from a respective UE for the respective communication link. The pilot signals assigned to different UEs may occupy the same orthogonal time-frequency resources.

Step 2: Optionally, a DFRC UE may send a request to the BS for initiating a radar sensing (e.g., a multi-static radar service) and await an acknowledgment from the BS.

Step 3: Optionally, upon reception of the request, the BS may start a session for the requesting DFRC UE. The session may be referred to as an active session. Optionally, from the estimated or reported position of the DFRC UE, the BS may find an existing or allocate a new cluster for the DFRC UE to join. The BS may send an acknowledgment message response to the DFRC UE.

Step 4: The BS sends a list to the DFRC UE containing the following information:
One or more pilot codebook key codes currently allocated to connected UEs (or UEs that are attached to the same cluster);
information about timing synchronization between a respective UE and the BS for each of the aforementioned pilot codebook key codes; and
An emitter identification code associated with each of the one or more aforementioned pilot codebook key codes.

Optionally, the list may be sent by the BS periodically in each active session.

Step 5: Upon receiving the aforementioned list from the BS, the DFRC UE may update a local database with the pilot signal information received in the list.

Step 6: The DFRC UE performs radar sensing and evaluates received echo signals as follows.

Step 6.1: If the echo signal is matched with (or corresponds to) one of the pilot signals defined in the list, the DFRC UE performs radar signal processing taking account of the received echo signal.

Step 6.2: If the echo signal is not matched with any of the pilot signals defined in the list, the DFRC UE may optionally look for a matched pilot signal in the local database.

Step 6.3: If a match is found, the DFRC UE performs radar signal processing taking account of the received echo signal.

Step 6.4: If no match is found, the DFRC UE discards the echo signal.

Step 7: The DFRC UE may optionally periodically checks the validity of each entry of the local database, and remove expired entries based on the expiration time.

Step 8: The BS may optionally check cluster consistency by verifying that each UE known position is consistent with a current clustering strategy.

Step 9: The BS may optionally periodically check pilot allocation consistency. If a UE is no longer connected, then BS releases the allocated pilot signal and notifies concerned DFRC UE(s) in the cluster.

Step 10: Optionally, when the DFRC UE is no longer connected to the BS, the BS may end an active session if there is any.

Optionally, the BS may share its pilot signal information to other BS(s) (e.g., a neighbouring BS). That is, base stations may mutually exchange their pilot signal information.

b)

Optionally, the BS itself may transmit pilot signals. In this case, the BS may include itself as a pilot emitter in the list provided to a DFRC UE. In this way, the BS itself also contributes to the multi-static radar scheme.

Optionally, for the purpose of maintaining communication links (e.g., to avoid pilot contamination), the BS may re-assign pilot attribution to a certain UE. The BS may update its local database, and notifies its serviced DFRC UE(s) and the other BS(s) for which it has exchanged pilot signal information.

Optionally, the BS may send a message to its serviced DFRC UE(s) to force clear a part or all of the pilot signal information stored on the serviced DFRC UE(s). The partial deletion may be emitter-based or pilot-based.

Optionally, the serviced DFRC UE may notify the BS to leave the active session at any time. After leaving the active session, the DFRC UE may still have a communications link with the BS.

Optionally, the BS may terminate an active session at any time. The BS may notify the DFRC UE prior to the session termination.

Optionally, the DFRC UE may determine that a received pilot signal from a further emitter satisfies a line of sight condition, e.g., by comparing a received power of a pilot signal to a certain threshold. That is, the pilot signal is directly emitted from the further emitter and directly received by the DFRC UE. This direct pilot signal may be used as a reference for location estimation based on reflected pilot signals (e.g., echoes/reflections of the pilot signals) from the same further emitter.

Optionally, connected UE(s) may periodically update position information to the BS. Alternatively or additionally, the BS may acquire UE position information based on any means known in the field for UE position estimation, e.g., based on signal strength. The position information may comprise one or more of the following:
absolute coordinates, e.g. GPS coordinates;
relative positioning data, such as angles of departure or arrival, delay of the dominant signal path, velocity of the UE, etc.;
beam directions for a pilot emitted by the UE; and
logical information, e.g. cluster proximity.

It is noted that features presented in this workflow may be optionally applied to corresponding elements of FIG. 1-7 mentioned above.

An application scenario of the invention may be to facilitate radar sensing performed by one or more autonomous cars within a region. Autonomous cars are equipped with radar units and at the same are capable of V2X communications. In this scenario, a network device, such as a road-side unit (RSU) and a road-side base station provides a list to an autonomous car. The list comprises pilot signal information assigned to a plurality of terminals including this autonomous car. The plurality of terminals further includes a terminal that is capable of communications only, for example, a mobile phone. The mobile phone emits pilot signal for channel estimation. In the meantime, the pilot signal emitted from the mobile phone also helps radar sensing performed by the autonomous car. The autonomous car may be able to receive (or detect) the pilot signal emitted from the mobile phone and any reflections/echoes thereof, and perform radar sensing based thereon. Moreover, the autonomous car may also be configured to emit a radar signal based on the pilot signal assigned to it. Due to the orthogonality between the pilot signals, the pilot signal emitted from the mobile and the pilot signal emitted from the autonomous car are also orthogonal. In this way, the interferences between radar and communications in the network may be mitigated.

It is noted that the devices (i.e., the network device and the first terminal) in the present disclosure may comprise processing circuitry configured to perform, conduct or initiate the various operations of the device described herein, respectively. The processing circuitry may comprise hardware and software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. Optionally, the processing circuitry comprises one or more processors and a non-transitory memory connected to the one or more processors. The non-transitory memory may carry executable program code which, when executed by the one or more processors, causes the device to perform, conduct or initiate the operations or methods described herein, respectively. For example, the first terminal may optionally comprise a radar unit adapted to perform steps related to radar sensing, and a communications unit adapted to perform steps related to communications (e.g., receiving the list). The radar unit and the communications unit may be connected and controlled by the one or more processors of the first terminal, and may be adapted to function according to the program code carried in the non-transitory memory of the first terminal.

The present disclosure has been described in conjunction with various aspects as examples as well as implementations. However, other variations can be understood and effected by those persons skilled in the art and practicing the claimed subject matter, from the studies of the drawings, this disclosure and the independent claims. In the claims as well as in the description the word “comprising” does not exclude other elements or steps and the indefinite article “a” or “an” does not exclude a plurality. A single element or another unit may fulfill the functions of several entities or items recited in the claims. The mere fact that certain measures are recited in the mutual different dependent claims does not indicate that a combination of these measures cannot be used in an advantageous implementation.

What is claimed is:

1. A network device (110) for a system configured for joint communications and radar, wherein the system comprises one or more first terminals (130) that are capable of radar and communications, and one or more second terminals that are capable of communications only, wherein the one or more first terminals (130) and the one or more second terminals (150) are connectable to the network device (110), and the network device (110) is configured to:
obtain a list (120) comprising pilot signal information assigned to the one or more first terminals (130) and the one or more second terminals (150); and
provide the list (120) to at least one of the one or more first terminals (130),
wherein each pilot signal information assigned to a respective terminal comprises:
an identification, ID, of a pilot sequence allocated to the respective terminal;
timing synchronization information between the respective terminal and the network device (110); and
an ID of the respective terminal.

2. The network device (110) according to claim 1, wherein the pilot signal information further comprises position information of the respective terminal.

3. The network device (110) according to claim 1, wherein the pilot signal information further comprises an expiration time of the pilot signal information.

4. The network device (110) according to claim 1, wherein the ID of the respective terminal comprises a temporary and/or anonymized ID code.

5. The network device (110) according to claim 1, wherein the network device (110) is further configured to determine one or more clusters based on beam orientation of the pilots and/or location information of the one or more first terminals (130) and the one or more second terminals (150).

6. The network device (110) according to claim 5, wherein the pilot signal information further comprises a cluster ID of the respective terminal.

7. The network device (110) according to claim 1, wherein the pilot signal information further comprises a network device ID.

8. The network device (110) according to claim 1, wherein the network device (110) is further configured to transmit one or more pilot signals, and the list (120) further comprises pilot signal information transmitted by the network device (110).

9. The network device (110) according to claim 1, wherein before providing the list (120) to the at least one of the one or more first terminals (130), the network device (110) is further configured to receive, from the at least one of the one or more first terminals (130), a request for requesting the list.

10. The network device (110) according to claim 1, wherein the network device (110) is further configured to send a request to each of the one or more first terminals (130) for updating and/or removing a part or all of the pilot signal information comprised in the list.

11. The network device (110) according to claim 1, wherein the network device (110) is further configured to:
provide the list (120) to a further network device (110); and/or
receive a further list (120) from the further network device.

12. A first terminal (130) for a system configured for joint communications and radar, wherein the system comprises a network device (110) and one or more second terminals (150) that are capable of communications only, wherein the first terminal (130) and the one or more second terminals (150) are connectable to the network device (110), and wherein the first terminal (130) is capable of radar and communications, and configured to:
receive, from the network device (110), a list (120) comprising pilot signal information assigned to the first terminal (130) and at least one of the one or more second terminals (150); and
perform radar sensing taking account of the pilot signal information comprised in the list,
wherein each pilot signal information assigned to a respective terminal comprises:
an identification, ID, of a pilot sequence allocated to the respective terminal;
timing synchronization information between the respective terminal and the network device (110); and
an ID of the respective terminal.

13. The first terminal (130) according to claim 12, wherein for performing the radar sensing, the first terminal (130) is further configured to:
receive one or more echo signals over radar; and
determine whether the one or more echo signals match one or more pilot signals defined in the list.

14. The first terminal (130) according to claim 13, wherein for performing the radar sensing, the first terminal (130) is further configured to send a pilot signal over radar based on pilot signal information that is comprised in the list (120) and is assigned to the first terminal (130).

15. The first terminal (130) according to claim 13, wherein after determining that there is one or more of the one or more echo signals matching the one or more pilot signals defined in the list, the first terminal (130) is configured to:
perform radar sensing based on the matched one or more echo signals received over radar.

16. The first terminal (130) according to claim 12, wherein the first terminal (130) is further configured to provide location information to the network device (110).

17. The first terminal (130) according to claim 12, wherein the first terminal (130) is further configured to:
receive a request from the network device (110) for updating and/or deleting a part or all of the pilot signal information comprised in the list; and
update and/or delete a part or all of the pilot signal information comprised in the list (120) according to the request.

18. A method (600) for a system configured for joint communications and radar, wherein the system comprises one or more first terminals that are capable of radar and communications, and one or more second terminals that are capable of communications only, wherein the one or more first terminals and the one or more second terminals are connectable to a network device, and wherein the method comprises:
obtaining (601), by a network device, a list comprising pilot signal information assigned to the one or more first terminals and the one or more second terminals; and
providing (602), by the network device, the list to at least one of the one or more first terminals,
wherein each pilot signal information assigned to a respective terminal comprises:
an identification, ID, of a pilot sequence allocated to the respective terminal;
timing synchronization information between the respective terminal and the network device; and
an ID of the respective terminal.

19. The method according to claim 18, wherein the pilot signal information further comprises position information of the respective terminal or an expiration time of the pilot signal information.

20. The method according to claim 18, wherein the ID of the respective terminal comprises a temporary and/or anonymized ID code.
